(19) United States
(12) Patent Application Publication
(10) Pub. No.: US 2025/0354922 A1
(43) Pub. Date: Nov. 20, 2025

(54) Optical Device for Monitoring the Silver Content of Thin Films

(71) Applicant: Silverpeutics, Inc., Livermore, CA (US)

(72) Inventors: Kevin Krogman, Brookdale, CA (US); Robert Moreno, Newark, CA (US); Jeremy L. Isbell, Manteca, CA (US)

(73) Assignee: Silverpeutics, Inc., Livermore, CA (US)

(21) Appl. No.: 19/203,667

(22) Filed: May 9, 2025

Related U.S. Application Data
(60) Provisional application No. 63/648,962, filed on May 17, 2024.

(51) Int. Cl. G01N 21/31; G01N 21/25; G01N 21/84

(52) U.S. Cl. CPC G01N 21/3103; G01N 21/255; G01N 21/8422

(57) ABSTRACT

An optical device having an Arduino controlled paired emitter-detector diode (“PEDD”) photometer to monitor silver content of a thin film is provided. The optical device is immune from background white light noise without further shrouding or room darkening.

### BACKGROUND OF THE INVENTION

In 1962, visible light-emitting diodes (“LEDs”) producing a narrow band of light wavelengths were discovered (Holonyak, N. Jr. et al., Coherent (visible) light emission from Ga (As1-xPx) junctions; Appl. Phys. Lett. 1, 82-83 (1962). Although L E D s can be used as alight source in spectrophotometers, L E D s may also be utilized as both the detector and light source in optical sensors using paired emitter-detector diodes (“PEDD”) (Bui, D. A. et al., Analytical devices based on light-emitting diodes. A review of the state-of-the-art, Anal. Chim. Acta 853, 46-58 (2015). PEDD-based photometers have a low fabrication cost, a low power consumption, are easily miniaturized, and have a good signal-to-noise ratio response across a wide wavelength range. In addition, their output is a direct pulse-duration-modulated signal, which eliminates the need for an expensive analog-to-digital conversion.

Due to these benefits, PEDD-based optical sensors are currently used in a variety of miniature photometers, as well as a flow-through optical sensor for flow analysis, particle detection and chromatography. Commercially available photometers/colorimeters are either single or multi-channels. In most of them, LEDs are used as the light sources not the detector. Single channel photometers utilize a LED of particular emission wavelength for a specific use. Thus, the optical device herein has been demonstrated to be highly efficient at quantifying one analyte: silver nanoparticles.

To this end, a low-cost optical device enables end-users to monitor silver content in a thin film application is disclosed. The described optical device employs an Arduino controlled PEDD photometer that has been constructed to monitor the silver content in these thin film applications. Additionally, the optical device described herein functions particularly well as a quality control method for yellow/amber items and/or articles, such as yellow shooting glasses, which are preferred over clear shooting glasses by many sportsmen and law enforcement professionals alike. These bright lenses enhance contrast, make the lighting seem brighter than it is, and improve visual acuity. Similarly, the disclosed device can provide a way to track yellow uniformity on a manufacturing line.

### SUMMARY OF THE INVENTION

In some aspects of the disclosure, an optical detection device is provided. The optical detection device includes a paired emitter-detector diode (“PEDD”) photometer capable of monitoring the silver content in a thin film. The optical detection system further includes at least two light-emitting diodes (“LED”) wherein a first LED directs light towards a thin film material and a second LED is designed to detect the light passing through the thin film material. In one embodiment, the LEDs are identical and function in the visible light range, which is between about 400 nm to about 800 nm. In another embodiment, the two LEDs operate at 400 nm. In another embodiment, the LED designed to detect light passing through a thin film material is able to sense light at 415 nm or shorter wavelength.

In an aspect of the invention, the optical device includes a ballast resistor, which serves to control current such that a circuit is protected against overcurrent and premature LED burnout. In another aspect of the invention, the PEDD photometer device contains a DC power source wherein the current flows in one direction, from the source to the device. In one embodiment, the DC power source is either a 5V, 12V or 24V. In one embodiment, the ballast resistor matches the DC power source.

In another aspect of the invention the optical device includes an Arduino, which contains both a physical programmable circuit board and an Integrated Development Environment (“IDE”) that runs on a computer and is capable of writing and uploading computer code to the physical board. The Arduino monitors the voltage generated by the photodiode: a light-emitting diode (“LED”) operating in reverse-bias on one of its analog input pins, and compares it to the reference baseline voltage which is collected with no sample film present. In one embodiment, the Arduino controlled device is configured such that the second L E D designed to detect the light passing through the thin film material is connected to the device in a reverse-bias manner functioning as a photodiode.

In another aspect of the invention, thin films include silver nanoparticles, and the silver nanoparticles absorb at about 410 nm. In one embodiment, the PE DD photometer optical device is capable of capturing an absorption spectrum of silver nanoparticles between about 10 nm and about 100 nm. In another embodiment, the silver nanoparticles described herein are about 20 nm.

In another embodiment, the second LED, which is designed to detect the light passing through the thin film material, receives at least 75% of transmitted light through the thin film from the light emitter. In one aspect of the invention, the thin film contains silver nanoparticles and the silver content in the thin film is correlated by the light transmission percent at 400 nm to silver content. In another aspect, a graphic plot of absorbance versus silver content is approximately linear, with the relationship that absorbance=2−log(% T) as measured by the light detector. In one embodiment, the PE DD photometer device and the second L E D designed to detect the light passing through the thin film material has a percent transmission (% T) between about 5 percent to about 90 percent. In another embodiment, the measured silver content in the thin film is less than about 30 μg/cm².

### BRIEF DESCRIPTION OF THE DRAWINGS

The accompanying drawings illustrate embodiments of the invention and serve as non-limiting examples used to explain the principles of the invention. Like references indicate similar elements among the figures and such elements are illustrated for simplicity and clarity and have not necessarily been drawn to scale. The embodiments illustrated herein are presently preferred, but the invention is not limited to the precise arrangements and combinations shown, wherein:

FIG. 1: Illustrates a plot of Absorbance vs silver content, which is expected to be approximately linear, with the relationship that Abs=2−log(% T). % T is the parameter measured with the photometer device.

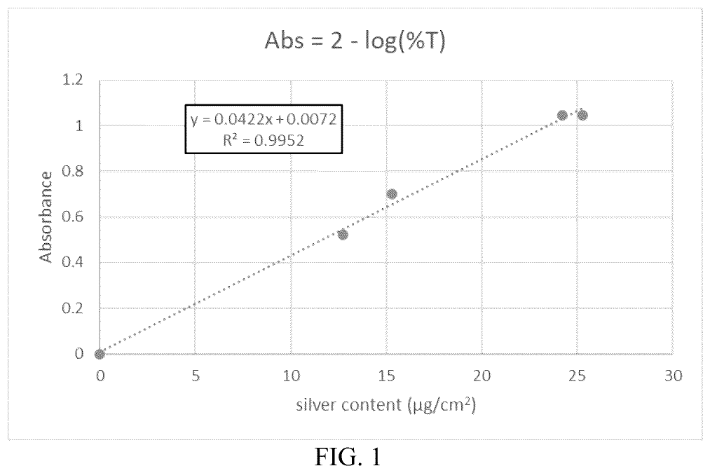

FIG. 2: Depicts the device/circuit described herein.

### DEFINITIONS

To facilitate an understanding of the invention set forth in the disclosure that follows, a number of terms are defined below.

As used herein and unless otherwise specified, the terms “coating” and “film” are used interchangeably.

As used herein, the term “laminate” refers to a laminated product that includes at least one or two surfaces and a laminating material.

As used herein, the term “laminating material” refers to a material that can mate two surfaces or cover both sides of a single surface. For example, a laminating material may be a PVB substrate with a porous coating on top, or an adhesive material (which can include a porous coating) that allows the formation of a laminate.

As used herein, “polymer multilayer” refers to the composition formed by sequential and repeated application of polymer(s) to form a multilayered structure. For example, hydrophilic polymer multilayers are polymer multilayers formed by the addition of polymers to a support.

The term “polymer multilayer” also refers to the composition formed by sequential and repeated application of polymer(s) to a solid support. In addition, the term “polymer layer” can refer to a single layer composed of polymer molecules existing either as one layer within multiple layers on a support. While the delivery of polymers can be sequential, the use of the term “polymer multilayer” is not limiting in terms of the resulting structure of the coating. It is well understood by those skilled in the art that inter-diffusion of polymers such as polyelectrolytes can take place leading to structures that may be well-mixed in terms of the distribution of the polymers used. It is also well understood by those skilled in the art that multilayer structures can be formed through a variety of interactions, including electrostatic interactions and others such as hydrogen bonding.

As used herein, the term “porous coating” refers to a porous coating covering a substrate, as well as any delamination products (e.g., films or particles) after a porous coating is removed from a substrate.

As used herein and unless otherwise specified, the term “solution” refers to a combination of at least one component in a liquid phase with at least one additional component dispersed or dissolved therein. The term includes homogeneous solutions (i.e., where the additional component is completely soluble in the liquid component). The term also includes mixtures (i.e., where the additional component is a solid that is not soluble or is not completely soluble in the liquid component).

As used herein, the term “sparingly soluble” refers to a material with a solubility of about 100 g/L or less, 50 g/L or less, 20 g/L or less, or 10 g/L or less, or 1 g/L or less, or 0.5 g/L or less, or 0.1 g/L or less.

As used herein and unless indicated otherwise, the term “substrate surface” (or sometimes simply “surface”), includes the surface of a substrate itself as well as the surface of any coatings deposited on the substrate (including a portion of a layer-by-layer coating), as well as a liquid layer present on a surface. Thus, for example, when a material is deposited on a substrate surface, the material may be deposited directly onto the surface of the substrate itself, or the material may be deposited onto the surface of a coating disposed on the substrate.

As used herein, “surfactant” refers to an amphiphilic material that modifies the surface and interface properties of liquids or solids. Surfactants can reduce the surface tension between two liquids. Detergents, wetting agents, emulsifying agents, dispersion agents, and foam inhibitors are all surfactants.

As used herein, the “thickness” of a bilayer refers to the average distance between the center of the nanoparticles that form the bilayer and the center of the nanoparticles that form an adjacent bilayer. With this definition, the following will be appreciated. First, the “center” of the nanoparticles of a given layer refers to a hypothetical plane intersecting the nanoparticles in such a way that minimizes the summation of the perpendicular distances between the plane and the center of each individual nanoparticle. Second, this definition is only relevant for a coating having more than one bilayer, and for a coating having “n” bilayers, only n−1 thicknesses are definable. Third, each bilayer having two adjacent bilayers (i.e. one above and one below) can have two thicknesses.

As used herein, by a “tightly packed” layer of nanoparticles is meant that the nanoparticles form a substantially homogeneous monolayer with a high packing density of nanoparticles. By high packing density, this includes packing arrangements that include hexagonal close packed, random close packed, and other close packings known in the art. In some embodiments the three-dimensional density of monodisperse nanoparticle is greater than 50%, or greater than 55% or greater than 60%. In some aspects, the three dimensional density of monodisperse nanoparticle is between 50-64%, or 55-64, or 60-64%.

As used herein, the term “block copolymer” refers to a polymer consisting of at least two monomers. In a block copolymer, adjacent blocks are constitutionally different, i.e. adjacent blocks comprise constitutional units derived from different species of monomer or from the same species of monomer but with a different composition or sequence distribution of constitutional units. A block copolymer can be thought of as two homopolymers joined together at the ends.

As used herein, the term “solvent” refers to a liquid that can dissolve a substance. The term “organic solvent” refers to a solvent derived from a petroleum-based product.

As used herein, the term “exposable” refers to anything that is capable of being exposed. An exposable surface or molecule is one that is made available to interaction with other surfaces or molecules. For example, in the context of the present invention, a covalent modification agent is exposable to an agent; thus, the two agents can interact with each other and form covalent bonds.

The term “functionalized” refers to a modification of an existing molecular segment to generate or introduce a new reactive functional group (e.g., a maleimido or succinimidyl group) that is capable of undergoing reaction with another functional group (e.g., a sulfhydryl group) to form a covalent bond. For example, a component containing carboxylic acid (—COOH) groups can be functionalized by reaction withN-hydroxy-succinimide or N-hydroxysulfosuccinimide using known procedures, to form a new reactive functional group in the form of an activated carboxylate (which is a reactive electrophilic group), i.e., anN-hydroxysuccinimide ester or an N-hydroxysulfosuccinimide ester, respectively. In another example, carboxylic acid groups can be functionalized by reaction with an acyl halide, e.g., an acyl chloride, again using known procedures, to provide a new reactive functional group in the form of an anhydride.

As used herein, the term “aqueous solution” includes solutions, suspensions, dispersions, colloids, and the like containing water.

As used herein, the terms “nanoparticle” and “nanoscale particles” are used interchangeably and refer to a nanoscale particle with a size that is measured in nanometers.

Examples of nanoparticles include nanobeads, nanofibers, nanohorns, nano-onions, nanorods, and nanoropes.

### DETAILED DESCRIPTION OF THE INVENTION

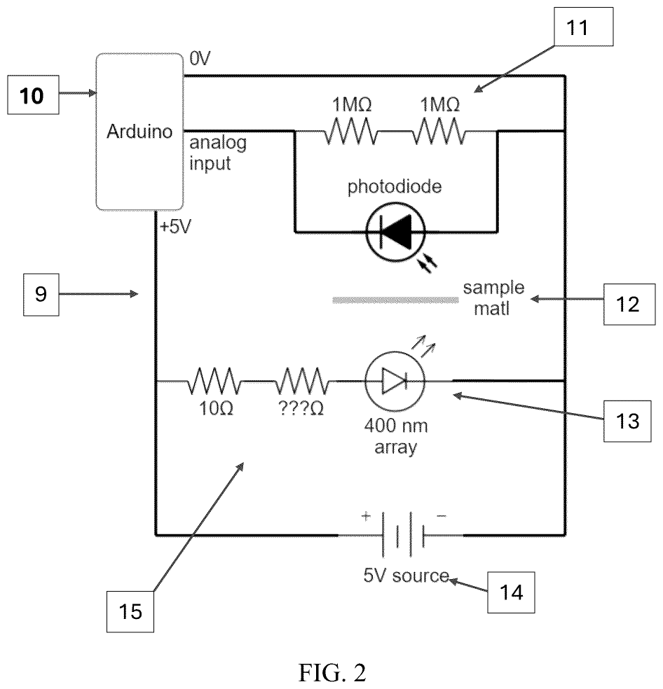

As illustrated in FIG. 2, a paired emitter-detector diode (PEDD)-based photometer optical device (9) was constructed utilizing two identical 400 nm LEDs wherein a first LED functions as the light emitter (13) and the second LED serves as a light detector/photodiode (11). A power source (14) an Arduino (10) and a ballast resistor (15). Only narrow bandwidth 400 nm light is passed through the sample material/film (12), and only 400 nm light is sensed on the other side via the photodiode (11) after the film absorbs it. In one embodiment, the power source is a DC power source and can include, but is not limited to batteries, solar cells, fuel cells, and DC transformers.

The optical device shown herein, the second LED is wired into the circuit in reverse-bias orientation thus creating a photodiode (11), thus operating as a photodiode. An LED is sensitive to wavelengths equal to or shorter than the peak wavelength they emit, in one embodiment the selected wavelength is 400 nm. Although this might appear to limit the use of the PE DD, in the present embodiment, it means this particular device does not need to be packaged tightly in a dark box to avoid stray light noise. Lower energy light does not affect the detector sensitivity. When the device is operating in an ambient light environment, it is most useful when fitted with 425 nm or shorter peak wavelength LEDs, preferably closer to 400 nm LEDs.

The optical device described herein functions particularly well for yellow/amber items and/or articles as the device takes advantage of the fact that it is not necessary to operate in a black room or inside a box to get good signal-to-noise. The optical device picks up on only a narrow range of light that it emits out, not the stray visible light in the room. Its readily applicable to silver nanoparticle films, or other yellow articles. For example, as stated above, yellow shooting glasses to track and/or monitor yellow uniformity on a manufacturing line. Or for silver nanoparticle films for catalysis. In practice the optical device described herein, can apply to many other products or industries where quantifying yellow color (blue absorption) would be useful.

In one embodiment, the device has been modified to include the LCD readout, which is employed to visualize the 400 nm transmission after the Arduino performs a variety of calculations and a momentary push button switch, which is used to set the baseline voltage reading with no film present. The Arduino monitors the voltage generated by the photodiode, which is an L E D operating in reverse-bias, on one of the analog input pins, and compares it to the reference baseline voltage that can be collected with no sample film present.

In one aspect, an array of 400 nm LED's stripped from a UV flashlight, which is pre-formed into an about one (“1”) inch diameter package for easy mounting. This form of packaging broadens the illuminated area and increases the emitter intensity, greatly simplifying alignment with the photodiode. The pre-formed array of LED's, however, comes with its own ballast resistor to limit current through the LEDs and prevent burnout and the exact resistance is unknown.

In another aspect of the invention, the power source is a rechargeable 5V battery pack, which provides a very sufficient power source as the PEDD system herein only consumes approximately 170 mA during a typical operation, thus a basic 5000 mA h battery pack will last more than 29 hours before requiring a recharge.

The device described herein does not require a radioactive source to operate and is immune from background white light noise without further shrouding or room darkening. The Arduino, which contains both a physical programmable circuit board and an Integrated Development Environment (“IDE”) that runs on a computer, is capable of writing and uploading computer code to the physical board.

### Silver Nanoparticles

Silver nanoparticles are capable of absorbing and scattering light with extraordinary efficiency. Their strong interaction with light occurs as the conduction electrons on the metal surface undergo a collective oscillation when they are excited by light at specific wavelengths. This oscillation is known as a surface plasmon resonance (“SPR”), and it causes the absorption and scattering intensities of silver nanoparticles to be much higher than identically sized non-plasmonic nanoparticles. The color of silver nanoparticles can appear yellow or other colors depending on their size and shape. This phenomenon is known as the “plasmonic effect.” When nanoparticles are very small, typically on the order of nanometers, they interact with light in ways that depend on their size and shape.

The optical properties of silver nanoparticles are highly dependent on the nanoparticle diameter. The silver-containing nanoparticles have a particle size of for example less than about 100 nm, less than about 50 nm, less than about 25 nm, or less than about 10 nm. In one embodiment, the silver nanoparticles are preferably about 20 nm. The particle size is defined herein as the average diameter of silver-containing particle core, excluding the stabilizer, as determined by transmission electron microscopy (“TEM”). Generally, a plurality of particle sizes may exist in the silver-containing nanoparticles obtained from the preparation. In embodiments, the existence of different sized silver-containing nanoparticles is acceptable. Smaller nanospheres primarily absorb light and have peaks between about 400 nm to about 415 nm, and preferably about 410 nm.

Silver nanoparticle optical properties also depend on the refractive index near the nanoparticle surface. As the refractive index near the nanoparticle surface increases, the nanoparticle extinction spectrum shifts to longer wavelengths (known as red-shifting). Practically, this means that the nanoparticle extinction peak location will shift to shorter wavelengths (blue-shift) if the particles are transferred from water (n=1.33) to air (n=1.00), or shift to longer wavelengths if the particles are transferred to oil (n=1.5).

The optical properties of silver nanoparticles change when particles aggregate and the conduction electrons near each particle surface become delocalized and are shared amongst neighboring particles. When this occurs, the surface plasmon resonance shifts to lower energies, causing the absorption and scattering peaks to red-shift to longer wavelengths. UV-Visible spectroscopy can be used as a simple and reliable method for monitoring the stability of nanoparticle solutions. As the particles destabilize, the original extinction peak will decrease in intensity (due to the depletion of stable nanoparticles), and often the peak will broaden or a secondary peak will form at longer wavelengths (due to the formation of aggregates). When all the wavelengths are shown together, known as white light, the silver nanoparticles in a manufactured thin film described herein absorb high energy blue light, while passing the rest of the spectrum. As a result, the silver nanoparticle containing thin films appear reddish-yellow in color.

Suitable silver compounds include organic and inorganic silver compounds. In embodiments, the silver compounds include silver acetate, silver carbonate, silver nitrate, silver perchlorate, silver phosphate, silver trifluoroacetate, silver benzoate, silver lactate, and the like, or mixtures thereof in any suitable ratio.

In some embodiments, the silver-containing nanoparticles are composed of elemental silver or a silver composite. Besides silver, the silver composite includes either or both of (i) one or more other metals and (ii) one or more non-metals. Suitable other metals include for example Al, Au, Pt, Pd, Cu, Co, Cr, In, and Ni, particularly the transition metals for example Au, Pt, Pd, Cu, Cr, Ni, and mixtures thereof. Exemplary metal composites are Au-A g, Ag-Cu, Au-Ag-Cu, and Au-Ag-Pd. Suitable non-metals in the metal composite include for example Si, C, and Ge. The various components of the silver composite may be present in an amount ranging for example from about 0.01% to about 99.9% by weight, particularly from about 10% to about 90% by weight. In embodiments, the silver composite is a metal alloy composed of silver and one, two or more other metals, with silver comprising for example at least about 20% of the nanoparticles by weight, particularly greater than about 50% of the nanoparticles by weight. Unless otherwise noted, the weight percentages recited herein for the components of the silver-containing nanoparticles do not include the stabilizer.

Silver-containing nanoparticles composed of a silver composite can be made for example by using a mixture of (i) a silver compound (or compounds) and (ii) another metal salt (or salts) or another non-metal (or non-metals) in the reaction.

The preparation of silver-containing nanoparticle compositions, which are suitable for the preparation of conductive elements for electronic applications can be carried out using all or some of the following procedures: (i) addition of a scavenger to the final reaction mixture from the preparation of silver-containing nanoparticles to destroy excess reducing agent; (ii) concentrating the reaction mixture by removing solvent; (iii) adding the concentrated reaction mixture to a non-solvent (or vice versa) to precipitate the silver-containing nanoparticles; (iv) collecting the silver-containing nanoparticles by filtration or centrifugation to result in isolated silver-containing nanoparticles (with the stabilizer molecules on the surface of the silver-containing nanoparticles); (v) dissolving or dispersing (assisted by for example ultrasonic and/or mechanical stirring) the isolated silver-containing nanoparticles (with molecules of the stabilizer on the surface of the silver-containing nanoparticles) in an appropriate liquid.

Silver-containing nanoparticle compositions can also be made by mixing silver-containing nanoparticles with other metal or non-metal nanoparticles.

In embodiments, it may be possible to form a silver-containing nanoparticle composition (with stabilizer molecules on the surface of the silver-containing nanoparticles) suitable for forming conductive elements for electronic applications without the need for the above-described procedures to isolate the silver-containing nanoparticles from the reaction mixture. In such embodiments, the reaction mixture (optionally augmented with another liquid which may be the same or different from the solvent used in the reaction mixture) may be considered the silver-containing nanoparticle composition.

The fabrication of an electrically conductive element from the silver-containing nanoparticle composition (“composition”) can be carried out by depositing the composition on a substrate using a liquid deposition technique at any suitable time prior to or subsequent to the formation of other optional layer or layers on the substrate. Thus, liquid deposition of the composition on the substrate can occur either on a substrate or on a substrate already containing layered material (e.g., a semiconductor layer and/or an insulating layer).

The phrase “liquid deposition technique” refers to deposition of a composition using a liquid process such as liquid coating or printing, where the liquid is a solution or a dispersion. The silver-containing nanoparticle composition may be referred to as an ink when printing is used. Illustrative liquid coating processes include for example spin coating, blade coating, rod coating, dip coating, and the like. Illustrative printing techniques include for example lithography or offset printing, gravure, flexography, screen printing, stencil printing, inkjet printing, stamping (such as microcontact printing), and the like. Liquid deposition deposits a layer of the composition having a thickness ranging from about 5 nanometers to about 5 millimeters, preferably from about 10 nanometers to about 1000 micrometers. The deposited silver-containing nanoparticle composition at this stage may or may not exhibit appreciable electrical conductivity.

As used herein, the term “heating” encompasses any technique(s) that can impart sufficient energy to the heated material to cause the desired result such as thermal heating (e.g., a hot plate, an oven, and a burner), infra-red (“IR”) radiation, microwave radiation, or UV radiation, or a combination thereof.

### Thin Films

In addition to the silver nanoparticles in the thin films described herein, the films may also contain one or more polymers. The polymers useful herein can be water soluble and bio-resorbable (biodegradable and biocompatible), for example polyvinyl alcohol (PVA), polycaprolactone(PCL), polylactic acid (PLA), poly(lactic-co-glycolic acid) (PLGA), polyurethane (PU), and polyethylene oxide/polyethylene glycol (PEO/PEG), polyvinylpyrrolidone (PV P). Additionally, desirable properties of the thin films include good mechanical strength and flexibility.

The thin films can be functionalized. The thin film can have one or more polymers, preferably biocompatible, or is formed from one or more proteins, or is a combination of polymers and proteins. A thin film can be made of synthetic polymers such as synthetic polyelectrolytes. The thin film can be made from naturally occurring polymers such as polysaccharides. The thin film can be made of multiple layers of the same or different hydrophilic polymers.

Thin films described herein can be made from hydrophilic polymers such as polyvinyl alcohol (“PVA”), polydiallyldimethylammonium chloride, polyacrylic acid, sulfonated polystyrene, chitosan, chitin, carboxymethylcellulose, hyaluronic acid, polyvinylpyrollidone, polyvinylalcohol, polyallylamine, polythiophenes, polyethyleneimines, polyacrylamides or copolymers or combinations thereof. In one aspect, the thin film is made from a hydrophilic polymer that is GRAS (generally regarded as safe) including, for example, polysaccharides, chitosan, starch, alginate, dextran, dextrin, chitin, guar gum, gum karaya, agar, Fenugreek seed mucilage, Soy polysaccharide, Gellan gum, Mango peel pectin, Lepidium sativum mucilage, Plantago ovata seed mucilage, Aegle marmelos gum, Locust bean gum, Lepidium sativum, Mangifera indica gum, Hibiscus rosa-sinensis mucilage, carrageenan, hyaluronic acid, carboxymethylcellulose, camauba wax, carob bean gum, carotene, cellulose, gelatin, gum Arabic, gum Ghatti, gum gualac, gum tragacanth, hydroxypropylmethyl cellulose, polyethylene glycol (“PEG”), methylcellulose, propylene glycol.

Thin films described herein can also be made from other hydrophilic polymers such as, for example, polyacrylamide, poly(2-acrylamido-2-mewthylpropane sulfonic acid), poly(2-acrylamido-2-methylpropanesulfonic acid), poly(N,N-diethyl acrylamide), ploy(N-isopropyl acrylamide), poly(N,N-dimethyl acrylamide), poly(N,N-dimethylaminopropyl acrylamide), poly(N-phenethyl methylacrylamide), poly(acrylic acid), poly(alpha-ethylacrylic acid), poly(methacrylic acid), poly(alpha-propylacrylic acid), poly(2-aminoethyl methacrylate), poly(2-hydroxyethyl methacrylate), poly(N,N-dimethylaminoethyl methacrylate), poly(4-styrene sulfonic acid), poly(N-vinyl acetamide), poly(N-vinyl formamide), poly(N-vinyl isobutyramide), poly(vinylamide), poly(N-vinyl pyrrolidone) (PVP polymers), poly(2-vinyl pyrazine), poly(N-vinyl imidazole), poly(2-vinyl pyridine), poly(ethylene imine), poly(methyl vinyl ether), poly(oxymethylene), poly(tetrahydrofuran), polyglutamic acid, acrylic polymers and copolymers include acrylic acid, acrylamide, and maleic anhydride polymers and copolymers, for example alylamines, ethylenimines, oxazolines, and other polymers with amine groups in their main or side chains are examples of amine-functional polymers, ether polymers, fluorocarbon polymers, polystyrene polymers, poly(vinylchloride) polymers, natural polymers, semisynthetic polymers, and synthetic polymers. For example, seethe polymers in Erothu et al, Hydrophilic Polymers (ed. Raju Francis and Sakthi Kumar), 2016, Wiley doi.org/10.1002/9783527690916.ch7, which is incorporated by reference in its entirety for all purposes.

The hydrophilic polymers can be positively charged or negatively charged. Examples of positively charged polymers include, for example, poly(allylamine hydrochloride) (“PAH”), polyl-lysine (“PLL”), poly(ethylene imine) (“PEI”), poly(histidine), poly(N,N-dimethyl aminoacrylate), poly(N,N,N-trimethylaminoacrylate chloride), poly(methyacrylamidopropyltrimethyl ammonium chloride), and natural or synthetic polysaccharides such as chitosan. Examples of negatively charged polymers include, for example, poly(acrylic acid) (“PAA”), poly(styrenesulfonate) (“PSS”), alginate, hyaluronic acid, heparin, heparan sulfate, chondroitin sulfate, dextran sulfate, poly(methacrylic acid), oxidized cellulose, carboxymethyl cellulose, polyaspartic acid, and polyglutamic acid.

The thin films can also incorporate amphoteric polymers, alone in combination with the other polymers described herein. Amphoteric polymers include, for example, one or more of acrylic acid (“AA”), DMAEMA (dimethylaminoethyl methacrylate), APA (2-aminopropyl acrylate), MorphEMA (morpholinoethyl methacrylate), DEAEMA (diethylaminoethyl methacrylate), t-ButylAEMA (t-butylaminoethyl methacrylate), Pip EMA (piperidinoethyl methacrylate), AEMA (aminoethyl methacrylate), HEMA (2-hydroxyethyl methacrylate), MA (methyl acrylate), MAA (methacrylic acid) APMA (2-aminopropyl methacrylate), AEA (aminoethyl acrylate). The amphoteric polymer can include (a) carboxylic acid, (b) primary amine, and (c) secondary and/or tertiary amine. The amphoteric polymers can have an isoelectric point of 4 to 8, preferably 5 to 7 and have a number average molecular weight in the range of 10,000 to 150,000.

Other polymers that can be used to make the thin films are described in U.S. patent application Ser. No. 18/155,518, filed Jan. 17, 2023, (publication no. US20240009342) which is incorporated by reference in its entirety for all purposes.

The molecular weight of the hydrophilic polymer can be from 1-10000 kDa, 100 to 10000 kDa, 500 to 10000 kDa, 1000 to 10000 kDa, 50 to 500 kDa or 500 to 5000 kDa. The hydrophilic polymer can have a multimodal molecular weight distribution in the range 1 to 10000 kDa, 100 to 10000 kDa, 500 to 10000 kDa, 1000 to 10000 kDa, 50 to 500 kDa or 500 to 5000 kDa or can be a mixture of multiple polymers of unimodal or multimodal molecular weight distribution in the range 1-10000 kDa, 100 to 10000 kDa, 500 to 10000 kDa, 1000 to 10000 kDa, 50 to 500 kDa or 500 to 5000 kDa. The concentration of hydrophilic polymer in aqueous solution can be 1 to 10000 mM, 10 to 10000 mM, 100 to 10000 mM, 10 to 1000 mM, 10 to 500 mM, 10 to 50 mM, 1 to 50 mM, or 1 to 100 mM based on polymer repeat unit. The pH of the aqueous solution can be adjusted so that the hydrophilic polymer is at least 0.01% charged. The concentration of inorganic or organic salts can be from 1 to 10000 mM, 10 to 10000 mM, 100 to 10000 mM, 10 to 1000 mM, 10 to 500 mM, 10 to 50 mM, 1 to 50 mM, or 1 to 100 mM in the aqueous solution.

The thin films herein can have a surface area of at least 0.65, 1, 2, 5, 10, 100 or 500 square meters or from 0.65 to 1.0, 0.65 to 5.0, 0.65 to 10, 0.65 to 20, 0.65 to 50, 0.65 to 100, 0.65 to 200, 0.65 to 300, 0.65 to 400, 0.65 to 500, 1 to 10, 1 to 20, 1 to 50, 1 to 100, 1 to 200, 1 to 300, 1 to 400, 1 to 500, 2 to 10, 2 to 20, 2 to 50, 2 to 100, 2 to 200, 2 to 300, 2 to 400, 2 to 500, 5 to 10, 5 to 20, 5 to 50, 5 to 100, 5 to 200, 5 to 300, 5 to 400, 5 to 500, 10 to 20, 10 to 50, 10 to 100, 10 to 200, 10 to 300, 10 to 400, 10 to 500, 20 to 50, 20 to 100, 20 to 200, 20 to 300, 20 to 400, 20 to 500, 50 to 100, 50 to 200, 50 to 300, 50 to 400, or 50 to 500 square meters.

### Methods for Making Thin Films

Disclosed herein are processes for manufacture of a thin film comprising: a) providing a flexible substrate and having a surface area of greater than 0.52 square meters; b) depositing a polymer layer the low substrate surface; and c) introducing a bioactive agent into the polymer layer to provide a bioactive polymer layer. In an aspect, the surface area of thin film is greater than 0.65 square meters.

Thin films of the disclosure can be made by making a layer or layers of polymer (dissolved in water) applied using the following wet coating techniques, after which the wet film has to be dried to remove the solvent by convection using hot air, to speed things up, or ambient air. Applicable wet coating techniques include, for example, reverse-roll coating, knife-over-roll coating, M eyer rod coating, gravure, slot-die, dip coating, spin coating, and spray coating. Other methods for making the thin films herein include, for example, immersion, inkjet, flexographic, metering rod, blade, air knife, curtain, melt extrusion, solvent casting and any combinations of the methods described above. See, e.g., US PAT PU BL. 20140079884, US PAT PUBL. 20160068703, US PAT PUBL. 20120269973, US PAT PUBL. 20160114294, US PAT PUBL. 20140112994, U S PAT PUBL. 20150086599, Shiratori, Japanese Journal of Applied Physics Vol. 44, No. 3, 2005, L126-L128, and Grunlan, Industrial & Engineering Chemistry Research Vol. 53, 2014, 6409-6416, all of which are incorporated herein by reference in their entirety.

Reverse-roll coating utilizes a roller in close proximity to a moving web, which roller spins in the reverse direction of the plastic, forming a bead of fluid that travels with the passing plastic based on the gap between roller and plastic, and the viscosity of the solution. Reverse roll coating is described in, for example, Alonso et al., Process viscosity in reverse roll coating, Chemical Engineer. Res. Design 79:128-136 (2001); Ostness, Coating technology for flexible packaging, tappi.org/content/enewsletters/eplace/2006/06PLA50.pdf; Kapur, Flow phenomena in fixed-gap and gravure roll coating systems, etheses.whiterose.ac.uk/929/1/uk_bl_ethos_366501.pdf; ali et al., Theoretical study of the reverse roll coating of non-isothermal magnetohydrodynamics viscoplastic fluid, Coatings 10:940 (2020), each of which is incorporated by reference in its entirety for all purposes. Reverse-roll coating processes can be performed on commercially sold machines including, for example, those sold by New Era Converting Machinery Inc., Xiamen Simy Equipment Limited Co., Ltd., Dubois Equipment Company, LLC, Schaefer Machine Co., Pyradia Belfab, Technical Coating International, and the Union Tool Corporation.

Knife-over-roll coating uses a tapered blade positioned slightly above a passing web of plastic, allowing only a thin layer of fluid to remain on the plastic as it passes underneath. Knife over roll coating is described in, for example, Herrera, Versatility in coating operations—knife coatings, Coated Fabrics. 1991; 20(4):289-301. doi:10.1177/152808379102000408; Coyle, D.J. (1997). Knife and Roll Coating. In: Kistler, S. F., Schweizer, P. M. (eds) Liquid Film Coating. Springer, Dordrecht. doi.org/10.1007/978-94-011-5342-3_15; Grant, Application of Coatings to Continuous Webs. Journal of Coated Fabrics. 1977; 7(1):43-57, doi:10.1177/009346587700700104, each of which is incorporated by reference in its entirety for all purposes. Knife-over roll coating processes can be performed on commercially sold machines including, for example, those sold by Jessup Manufacturing Company, Delpro Limited, US Web Converting Machinery Corporation, National Coating Corporation, and Technical Coating International.

Meyer rod coating uses a rod with a spiral wrapped wire positioned such that it barely touches a passing plastic surface. The wire touches the film surface, and the rod in the middle is separated from the surface by the wire diameter. Only fluid which can fit through the gaps in the wire voids is allowed to remain on the passing plastic. Once it passes the Meyer rod the peaks and troughs created by the wire smooth out and level themselves prior to curing. M eyer rod coating is described in Kim et al, Multi-purpose overcoating layers based on PVA/silane hybrid composites for highly transparent, flexible, and durable AgNW/PEDOT:PSS films, RSC Adv. 6:19280-19287 (2016); Li et al., Roll-to-roll fabricating MXene membranes with ordered interlayer distanced for molecule and ion separation, Adv. M ater. Interfaces vol. 10, DOI:10.1002/admi.202300301 (2023), each of which is incorporated by reference in its entirety for all purposes. M eyer rod coating processes can be performed on commercially sold machines including, for example, those sold by Conversion Technologies, Inc., and Xiamen Simy Equipment Limited Co., Ltd.

Gravure uses a dimpled roller that dips into a trough of fluid and carries only what it can hold by surface tension out of the pan, a doctor blade scrapes the surface of the pits such that only fluid contained in the volume of the pits is allowed to remain. This dimpled roller then presses against a passing plastic surface, which is pressed into the dimples sufficiently to draw out all the fluid. These tiny mounds of fluid then settle into a liquid sheet of prescribed thickness before drying. Gravure coating is described in, for example, Wang et al., Large-area Gravure-printed AgNWs electrode on water/oxygen barrier substrate for long-term stable large-area flexible organic solar cells, Chinese J. Chem. 42:478-484 (2023); Kopola et al., High efficient plastic solar cells fabricated with a high-throughput gravure printing method, Solar Energy M at. Solar Cells 94:1673-1680 (2010); Sato et al., Stretchable, adhesive and ultra-conformable elastomer thin films, Soft M atter 12:9202-9209 (2016), each of which is incorporated by reference in its entirety for all purposes. Gravure coating processes can be performed on commercially sold machines including, for example, New Era Converting Machinery, Inc., Retroflex, Inc., Pyradia Belfab, Hirano Tecseed Co., Ltd., and Kerone Engineering Solutions, Inc.

Slot-die uses fluid that is metered onto a passing plastic surface by pressure through a narrow precisely machined slot between two metal surfaces. This technique requires very precise machining and a defect free gap between the two. Slot-die is described in, for example, Parsekian et al., Scalable, alternating narrow stripes of polyvinyl alcohol support and unmodified PEDOT:PSS with maintained conductivity using a single-step slot die coating approach, ACS A ppl. Mater. Interfaces 12:3736-3745 (2020); Jeong et al., Scaled production of functionally gradient thin films using slot die coating on a roll-to-roll system, ACS Appl. M ater. Interfaces 16:9264-9274 (2024); L in et al., Minimum wet thickness for double-layer slide-slot coating of poly(vinyl-alcohol) solutions, Polymer Engineer. Sci. 45:1590-1599 (2005), each of which is incorporated by reference in its entirety for all purposes. Slot-die processes can be performed on commercially sold machines including, for example, Ossila, FOM Technologies, MTI Corporation, M IRW EC Coating, and nTact.

In dip coating a passing plastic surface is submerged into a pan of fluid as it rides around a roller face. Anything that carries along and doesn't drain back into the pan is dried into a sheet of film. This technique is only applicable for specific viscosity ranges and speeds. In dip coating is described in, for example, Schiessi et al., Nanocomposite coatings based on polyvinyl alcohol and montmorillonite for high-barrier food packaging, Sec. Nutrition Food Sci. Technol. Vol. 9, doi.org/10.3389/fnut.2022.790157 (2022); Sinturel et al., Influence of PLGA nanoparticles on the deposition of model water-soluble biocompatible polymers by dip coating, Colloids and Surfaces A: Physiochemical and Engineering Aspects, 608:125591(2021), each of which is incorporated by reference in its entirety for all purposes. In dip coating processes can be performed on commercially sold machines including, for example, Xiamen Tmax Battery Equipment Limited., Ossila, Specialty Coating Systems, Inc., MSE Supplies, LLC, and PAR Systems.

Spin coating uses a fluid applied to the middle of a spinning substrate. As viscous forces overcome inertial forces, the fluid coats the surface as a thin layer. This technique is limited in size of substrate to that which can be spun safely. Spin coating is described in, for example, Manikandan et al., Construction of spin coating machine controlled by arm processor for physical studies of PVA, Inti J. Electronics Electrical Engineer. 3:318-322 (2015); Augustine et al., Excellent UV absorption in spin-coated thin films of oleic acid modified zinc oxide nanorods embedded in Polyvinyl alcohol, J. Phys. Chem. Solids 73:396-401 (2012); Moreira et al., Spin-coated freestanding films for biomedical applications, J. M at. Chem. B, 9:3778-3799 (2021), each of which is incorporated by reference in its entirety for all purposes. Spin coating processes can be performed on commercially sold machines including, for example, Ossila, Specialty Coating Systems, Inc., Holmarc Opto-Mechatronics Ltd., MTI Corporation, and MicroNano Tools.

Spray coating sprays fluid onto a surface but uniformity is challenging or very expensive equipment is required. Spray coating is described in, for example, Wei et al., Constructing anti-scaling and anti-wetting polyvinyl alcohol layers through spray-coating with improved water permeability in membrane distillation, Desalination, Volume 545, article id. 116161 (2023); Wang et al., Spray-coated tough thin film composite membrane for pervaporation desalination, Chem. Engineer. Res. Design 179:493-501(2022), each of which is incorporated by reference in its entirety for all purposes. Spray coating processes can be performed on commercially sold machines including, for example, SonoTek Corporation, SPS International, MTI Corporation, and Holmarc Opto-Mechatronics Ltd.

The thin films herein can be made on a substrate. The substrate can be a flexible sheet. The flexible sheet can be amenable to storage and winding onto a roll for use in a continuous roll-to-roll process. The flexible sheet can include, for example, a polyester film, a polyethylene terephthalate (“PET”) film, a biaxially oriented PET film, a polycarbonate, a polyethylene (including high density polyethylene, medium density polyethylene, low density polyethylene, linear low density polyethylene) film, a polyvinyl chloride film, a polyvinylidene chloride film, a polyvinylidenefluoride film, a nylon film, a polystyrene film, an acetate film, a polyurethane film, an ethylene vinyl acetate copolymer film, a cast polypropylene film, an uniaxially oriented polypropylene film and a biaxially oriented polypropylene films. The flexible sheet can include a release coating which can be a silicone release film, a polydimethyl siloxane (“PDMS”) coating, a fluorocarbon coating, a polyacrylate coating, a polystyrene coating, a polystyreneacrylic coating, a chromium sterate complex coating, or a polyolefin coating. Suitable release films include, but are not limited, to those provided St Gobain Performance Plastics, Worcester M ass., such as Saint Gobain 4130, 4159 and 7819 release coatings. The release coating can allow complete peeling of the thin film coating without tears or other defects thus resulting in a free-standing hydrophilic polymer film.

Other materials may be substituted for the flexible sheet Such other materials may be a paper or cellulosic substrate such as glassine or supercalendered kraft paper coated with a release coating.

The processes for making the thin films can also include steps to control the amount of a desired active agent and/or other additives in the hydrophilic polymer thin film by controlling the number of polymer layers, by controlling the pH when forming the polymer layer, and/or by controlling the number of introducing cycles.

The processes can form or deposit a second polymer layer (and/or multiple polymer layers) on the hydrophilic polymer-layer. The second polymer layer can slow the release of an agent and/or other additives from nanoscale layer by 1 to 1000 times, 1 to 100 times, 10 to 1000 times, 20 to 1000 times, 50 to 1000 times, 100 to 1000 times, 10 to 500 times, 50 to 500 times, 10 to 200 times or 20 to 200 times.

The second polymer layer can be a sacrificial polymer layer. The sacrificial polymer layer can be dissolvable or biodegradable and be made of a water-soluble polymer. The water-soluble polymer can be polyvinyl alcohol (PVA). The water-soluble polymer can have a molecular weight of less than 23 kDa. The water-soluble polymer can have a molecular weight such that it can be removed from the blood by renal filtration. The sacrificial polymer layer can have a water-soluble polymer dissolves when exposed to moisture on a surface so that the bioactive nanoscale polymer layer is deposited on the surface. In some embodiments, the second polymer layer comprises polyacrylic acid (“PAA”), polyvinylpyrrolidone (“PVP”), carboxymethyl cellulose (“CMC”), hydroxypropyl cellulose, hydroxypropyl methylcellulose, methylcellulose, ethylcellulose, hydroxyethyl cellulose (“HEC”), alginates, polyvinylacetate (PVAc), polylactic acid (PLA), polylactic-co-glycolic acid (PLGA), polyglycolic acid, or polyanhydrides.

The second polymer layer can include additives as discussed above, or can include surfactants, emulsifiers, wetting agents, rheology modifiers, plasticizers, emollients, humectants, disintegrants, lubricants, binders, compatibilizing agents, antistatic agents, and fillers. The second polymer layer can be from about 0.1 μm thick to about 100 μm thick, from about 0.1 μm thick to about 50 μm thick, from about 1 μm thick to about 20 μm thick, or from about 1 μm thick to about 10 μm thick.

The secondary polymer film can have a thickness of from about 1-50 μm, preferably about 5-25 μm, and can be coated onto the hydrophilic polymer layer. The second polymer layer can be made of a hydrogel, a hydrocolloid, and/or a collagen and such a second layer can provide support to the hydrophilic polymer layer.

An adhesive material can also be added to the thin films herein. Adhesive materials include, for example, polyvinyl butyral (“PVB”), polyacrylates, polymethyl methacrylates, vinyl acetates, polyvinyl alcohol, and the like. The adhesive material can be added to the thin film by any method known in the art.

A freestanding sheet can be obtained by peeling the combined hydrophilic polymer layer and second polymer layer from the substrate. This freestanding film may be referred to as a microsheet. The substrate supporting the hydrophilic polymer layer and second polymer layer can be cut to a predetermined size and/or state before the microsheet is peeled away. The hydrophilic polymer layer of a microsheet can contain an agent and/or other additives such as microparticles, nanoparticles, or magnetic particles as described above. The microparticles or nanoparticles in the hydrophilic polymer layer can contain bioactive agents or other useful agents. Further, the metal ion antibiofilm agent can be a gallium ion, a gallium ion salt, a gallium ion nanoparticle, an alloy of gallium, or an alloy of gallium and silver.

The disclosure provides a freestanding thin film of a desired size and shape as described above. The thin film may have a desired size and shape by cutting the substrate material to a desired size and shape and peeling the thin film from the substrate.

Various features and embodiments of the disclosure are illustrated in the following representative examples, which are intended to be illustrative, and not limiting. However, one skilled in the art will readily appreciate that the specific methods and results discussed are merely illustrative of the inventions as described more fully in the claims which follow thereafter. Unless otherwise indicated, the disclosure is not limited to specific procedures, materials, or the like, as such may vary. It is also to be understood that the terminology used herein is for the purpose of describing particular embodiments only and is not intended to be limiting.

Various features and embodiments of the disclosure are illustrated in the following representative examples, which are intended to be illustrative, and not limiting. However, one skilled in the art will readily appreciate that the specific methods and results discussed are merely illustrative of the inventions as described more fully in the claims which follow thereafter. Unless otherwise indicated, the disclosure is not limited to specific procedures, materials, or the like, as such may vary. It is also to be understood that the terminology used herein is for the purpose of describing particular embodiments only and is not intended to be limiting.

All publications, patents, patent applications and other documents cited in this application are hereby incorporated by reference in their entireties for all purposes to the same extent as if each individual publication, patent, patent application or other document were individually indicated to be incorporated by reference for all purposes.

While various specific embodiments have been illustrated and described, it will be appreciated that various changes can be made without departing from the scope of the invention(s) of the disclosure.

### EXAMPLES

### Example 1: Making an Optical Device Employing an Arduino Controlled Paired Emitter-Detector Diode (PEDD) Photometer

According to FIG. 2, a paired emitter-detector diode (PEDD)-based photometer device (9) was constructed utilizing two identical 400 nm LEDs (Chanzon 5 mm purple LEDs (100F5T-YT-WH-PU): purchased from Amazon)
wherein a first L E D functions as the light emitter (13) and the second L E D serves as a light detector/photodiode (11). A power source (5V DC, 5000 mA h power pack) (14) an Arduino (Elegoo UNO R3 board: Amazon) (10) and a ballast resistor (100 Ohm, Radio Shack, part 2710152) (15). Only narrow bandwidth 400 nm light is passed through the silver nanoparticle containing thin film (12), and only 400 nm light is sensed on the other side via the photodiode (11) after the film absorbs it.

1. A PEDD photometer optical device comprising:
a) two or more light emitting diodes with a peak wavelength of less than 425 nm wherein the paired detector LED senses only peak wavelength or shorter light when passing through a thin film;
b) a ballast resistor;
c) a DC power source; and
d) an Arduino.

2. The optical device of claim 1, wherein the two or more LEDs include one or more light emitting diodes that function as a light emitter and an additional light emitting diode which functions as a light detector.

3. The optical device of claim 2, wherein the group of LEDs are identical single-color light emitting diodes.

4. The optical device of claim 2, wherein the detector light emitting diode is connected to the device in a reverse-bias manner functioning as a photodiode.

5. The optical device of claim 1, wherein the thin film comprises silver nanoparticles.

6. The optical device of claim 5, wherein the silver nanoparticles absorb at about 410 nm.

7. The optical device of claim 6, wherein the device is capable of capturing an absorption spectrum of silver nanoparticles between about 10 nm and about 100 nm.

8. The optical device of claim 7, wherein the silver nanoparticles are about 20 nm.

9. The optical device of claim 2, wherein the light detector receives at least 75% of transmitted light through the thin film from the light emitter.

10. The optical device of claim 9, wherein the thin film comprises silver nanoparticles and the silver content in the thin film is correlated by the light transmission percent at 400 nm to silver content.

11. The optical device of claim 10, wherein a plot of absorbance versus silver content is approximately linear, with the relationship that absorbance=2−log(% T) as measured by the light detector.

12. The optical device of claim 11, wherein the percent transmission is between about 5 percent to about 90 percent.

13. The device of claim 12, wherein the measured silver content is less than about 30 μg/cm².

14. The optical device of claim 1, wherein the DC power source is selected from a 5V, a 12V or a 24V power source.

15. The optical device of claim 14, wherein the ballast resistor matches the DC power source.
